(19) United States
(12) Patent Application Publication
(10) Pub. No.: US 2010/0053149 A1
(43) Pub. Date: Mar. 4, 2010

(54) Display apparatus and display method

(75) Inventors: Naoto Inoue, Tokyo (JP); Kazunori Ohmura, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/583,695

(22) Filed: Aug. 25, 2009

(30) Foreign Application Priority Data
Aug. 29, 2008 (JP) P2008-221555

(51) Int. Cl. G06T 1/00; G06K 9/60

(52) U.S. Cl. 345/418; 382/306

(57) ABSTRACT

A display apparatus includes a content detector configured to, on the basis of meta data of content data being reproduced, detect associated content data associated with the content data being reproduced; and a display controller configured to cause a reproduction image contained in the content data being reproduced to be displayed on a display screen and cause associated images contained in the associated content data detected by the content detector to be displayed as a moving image on the display screen. The display controller causes associated images of different associated content data that is sequentially detected by the content detector to be sequentially displayed on the display screen in accordance with the change of the meta data of the content data being reproduced.

### CROSS-REFERENCE TO RELATED APPLICATION

The present application claims priority from Japanese Patent Application No. JP 2008-221555 filed in the Japanese Patent Office on Aug. 29, 2008, the entire content of which is incorporated herein by reference.

### BACKGROUND OF THE INVENTION

1. Field of the Invention

The present invention relates to a display apparatus and a display method.

2. Description of the Related Art

With the widespread use of digital recorders, digital cameras, and digital video cameras, it has become possible to store a large amount of data on personal experiences as digital data. However, content data available in one's immediate environment changes from one moment to the next. Even if a person is interested in viewing stored data in large quantities, the number of opportunities to find data the user is interested in and to view such data is limited.

A technology for providing content data that is expected to be of interest to a user from within stored content data has been disclosed in Japanese Unexamined Patent Application Publication No. 2001-101190. According to the technology disclosed in Japanese Unexamined Patent Application Publication No. 2001-101190, a preset user profile is checked against meta data of content data, and content data meeting the condition is divided into pieces and is provided to a user. As a result, it is possible to provide a user profile, that is, content data appropriate for each user, to the user.

### SUMMARY OF THE INVENTION

However, a user may change hobbies and interests from time to time, and may not fixed. Therefore, even if content data having meta data matching a user profile is provided, it may not necessarily match an object of a user's interest at that point in time. In addition, the fact that the content data is based on a user profile leads to a possibility that the same content data is repeatedly provided many times.

It is desirable to provide a new and improved display apparatus and display method that are capable of providing appropriate content data in accordance with the interests of a user, which change from time to time.

According to an embodiment of the present invention, there is provided a display apparatus including: a content detector configured to, on the basis of meta data of content data being reproduced, detect associated content data associated with the content data being reproduced; and a display controller configured to cause a reproduction image contained in the content data being reproduced to be displayed on a display screen and cause associated images contained in the associated content data detected by the content detector to be displayed as a moving image on the display screen, wherein the display controller causes associated images of different associated content data that is sequentially detected by the content detector to be sequentially displayed on the display screen in accordance with the change of the meta data of the content data being reproduced.

With this configuration, on the basis of meta data of content data being reproduced, the content search unit allows associated content data associated with the content data to be detected. Then, the display controller allows the reproduction image of the content data being reproduced to be displayed on the display screen and also allows associated images contained in the detected associated content data to be displayed as a moving image on the display screen. At this time, when the meta data is changed, the content search unit sequentially detects different associated content data on the basis of the meta data. Then, the display controller allows associated images of different associated data that is sequentially detected to be displayed on the display screen. Therefore, it is possible to provide associated content data associated with content data being reproduced in sequence each time meta data is changed. Usually, the user is interested in the reproduced content data, and often the user is interested in data associated from the object of interest. Accordingly, it is possible for the display apparatus to sequentially provide associated content data associated with the content data being reproduced. Furthermore, at this time, according to the display apparatus, since associated content is displayed as a moving image, it is possible to provide the associated content in such a manner that the association characteristics associated with the content being reproduced are accentuated.

The display controller may cause the reproduction image to be displayed in the central area of the display screen and may cause the associated images to be displayed in the peripheral area of the central area on the display screen in such a manner that the reproduction image and the associated images do not superpose one another.

The content detector may detect a plurality of associated content data having the same association characteristic with respect to the content data being reproduced, and the display controller may cause the associated images of the plurality of associated content data having the same association characteristic to be displayed in the peripheral area together with the reproduction image.

The display controller may cause the associated images of the plurality of associated content data having the same association characteristic to be sequentially displayed in the peripheral area.

The content detector may detect a plurality of associated content data having an association characteristic and a plurality of associated content data having another association characteristic with respect to the content data being reproduced, and the display controller may cause the associated images of the plurality of associated content data having the association characteristic to be sequentially displayed in the peripheral area and may cause the associated images of the plurality of associated content data having the other association characteristic to be sequentially displayed in the peripheral area.

On the basis of meta data of each of the plurality of associated content data having the same association characteristic, the display controller may cause associated images of a plurality of associated content data each having an association characteristic differing from the same association characteristic to be sequentially displayed in the peripheral area, and may cause the associated images of a plurality of associated content data each having another association characteristic to be sequentially displayed in the peripheral area.

On the basis of meta data of content data that is continuously reproduced before or after the content data being reproduced, the content detector further may detect associated content data associated with the content data that is continuously reproduced, and the display controller may cause the associated images of the associated content data associated with the content data that is continuously reproduced to be displayed as still images on the display screen in such a manner as to be arranged with the associated images of the associated content data associated with the content data being reproduced.

The display controller may cause the associated images of the plurality of associated content data having the same association characteristic to be displayed in such a manner as to be arranged in the peripheral area.

The content detector may detect a plurality of associated content data having an association characteristic and a plurality of associated content data having another association characteristic with respect to the content data being reproduced, and the display controller may cause the associated images of the plurality of associated content data having the association characteristic to be displayed in such a manner as to be arranged in one side of the central area in the peripheral area, and may cause the associated images of the plurality of associated content data having the other association characteristic to be displayed in such a manner as to be arranged on the other side of the central area in the peripheral area.

On the basis of meta data of each of the plurality of associated content data having the same association characteristic, the display controller causes the associated images of the plurality of associated content data each having an association characteristic differing from the same association characteristic to be displayed in such a manner as to be arranged in one side of the central area in the peripheral area, and causes the associated images of the plurality of associated content data each having another association characteristic to be displayed in such a manner as to be arranged in the other side of the central area in the peripheral area.

According to another embodiment of the present invention, there is provided a display method including the steps of: on the basis of meta data of content data being reproduced, detecting associated content data associated with the content data being reproduced; and causing a reproduction image contained in the content data being reproduced to be displayed on a display screen and causing associated images contained in the associated content data detected in the content detection step to be displayed as a moving image on the display screen, wherein, in the display step, the associated images of the different associated content data that is sequentially detected in the content detection step are to be sequentially displayed on the display screen in accordance with the change of the meta data of the content data being reproduced.

As described above, according to the embodiments of the present invention, it is possible to provide appropriate content data in accordance with the interests of a user, which change moment by moment.

### BRIEF DESCRIPTION OF THE DRAWINGS

FIG. 1 is an illustration showing the outline configuration of a display system according to a first embodiment of the present invention;

FIG. 2 is an illustration showing the configuration of the display apparatus according to the embodiment of the present invention;

FIG. 3A is an illustration conceptually illustrating the operation of the display apparatus according to the embodiment;

FIG. 3B is an illustration conceptually illustrating the operation of the display apparatus according to the embodiment;

FIG. 3C is an illustration conceptually illustrating the operation of the display apparatus according to the embodiment;

FIG. 4 is an illustration showing the operation of the display apparatus according to the embodiment;

FIG. 5A is an illustration showing an example of the display apparatus according to the embodiment;

FIG. 5B is an illustration showing an example of the display apparatus according to the embodiment;

FIG. 5C is an illustration showing an example of the display apparatus according to the embodiment;

FIG. 5D is an illustration showing an example of the display apparatus according to the embodiment;

FIG. 5E is an illustration showing an example of the display apparatus according to the embodiment;

FIG. 5F is an illustration showing an example of the display apparatus according to the embodiment;

FIG. 6A is an illustration showing a first modification of the display apparatus according to the embodiment;

FIG. 6B is an illustration showing a second modification of the display apparatus according to the embodiment;

FIG. 6C is an illustration showing a third modification of the display apparatus according to the embodiment;

FIG. 7A is an illustration showing a fourth modification of the display apparatus according to the embodiment;

FIG. 7B is an illustration showing a fifth modification of the display apparatus according to the embodiment; and

FIG. 7C is an illustration showing a sixth modification of the display apparatus according to the embodiment.

### DESCRIPTION OF THE PREFERRED EMBODIMENTS

Preferred embodiments of the present invention will be described in detail below with reference to the attached drawings. In this specification and drawings, components having substantially the same functions are designated with the same reference numerals, and accordingly, duplicated descriptions thereof are omitted.

It is possible for the display apparatus according to each of the embodiments of the present invention to be described below to display at least one item of associated content data, which is associated with the content data while one item of content data is being reproduced. To facilitate easy understanding, the display apparatus will be described in the following order.

### 1. First Embodiment

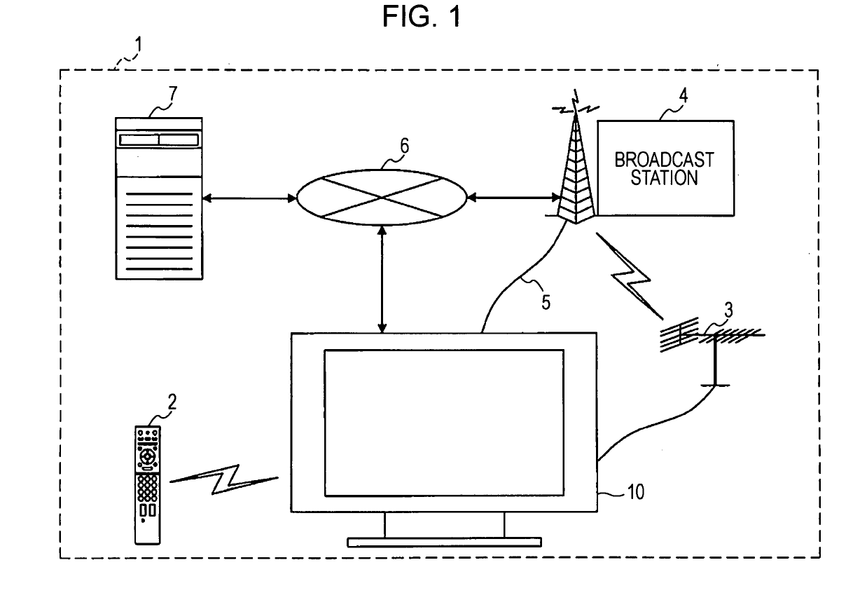

### 1-1. Configuration of Display System, FIG. 1

### 1-2. Example of Content Data

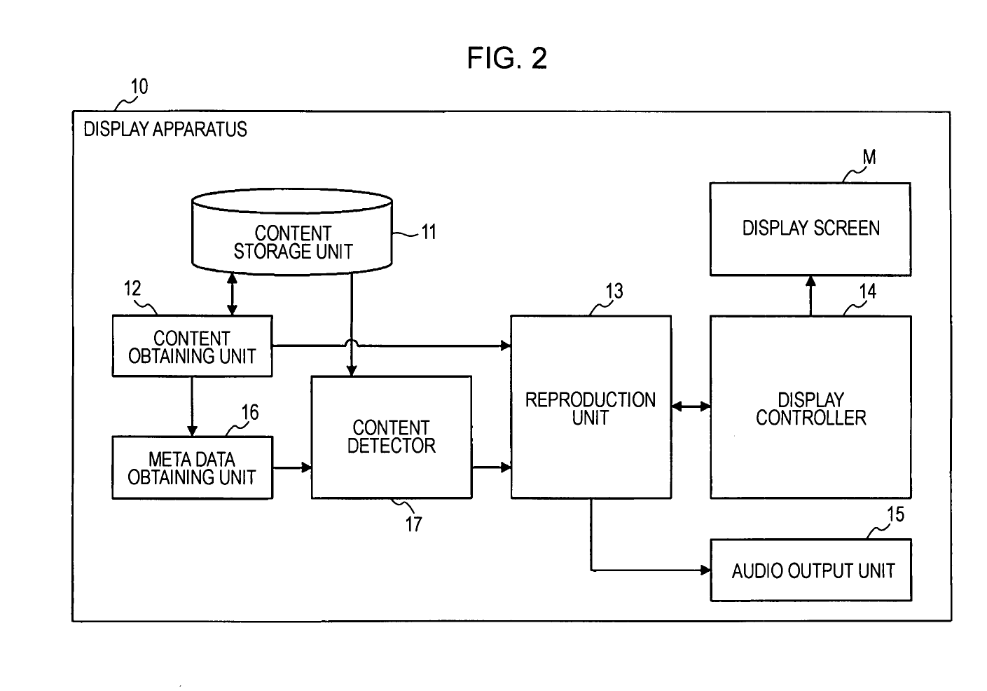

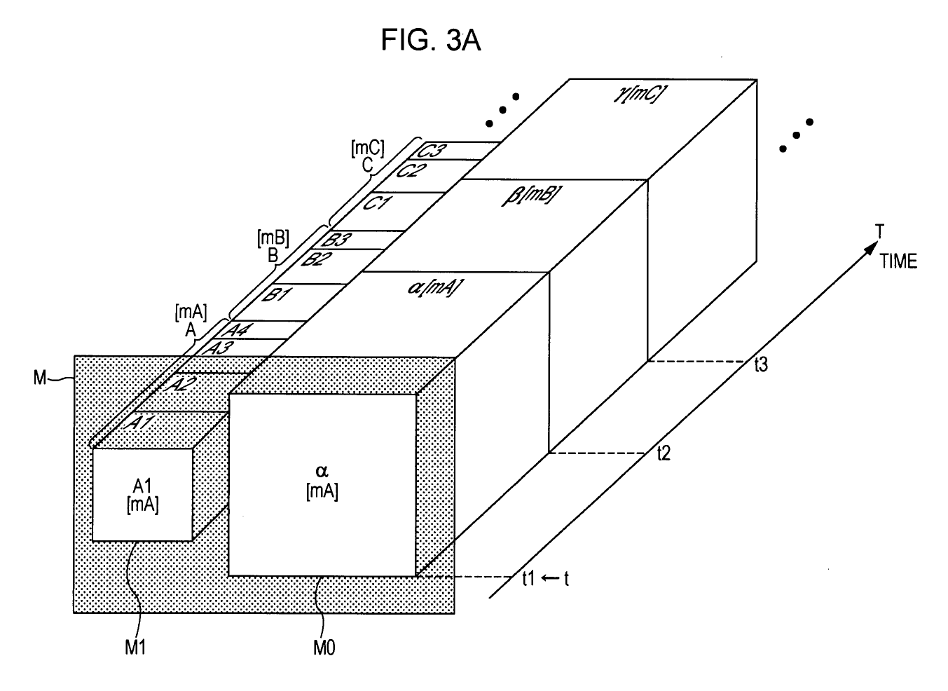

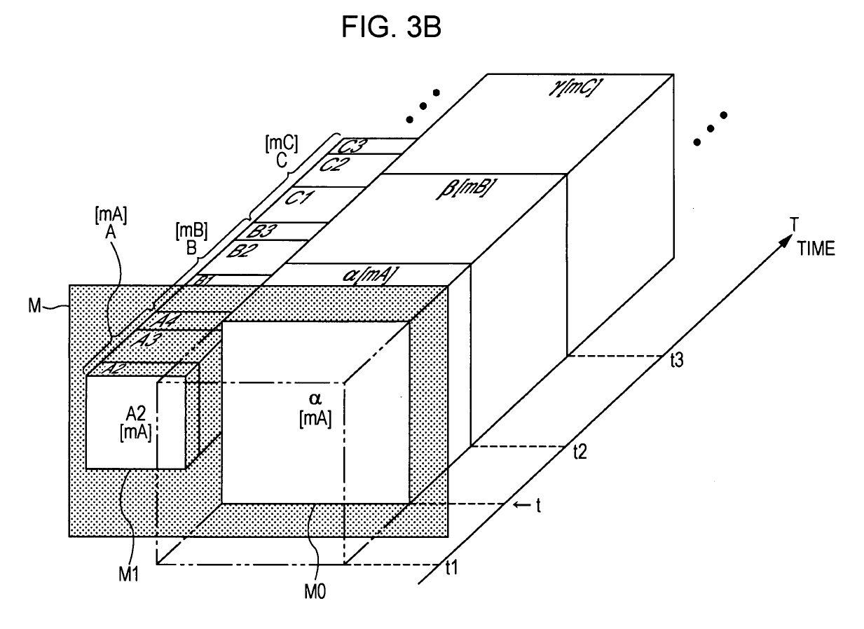

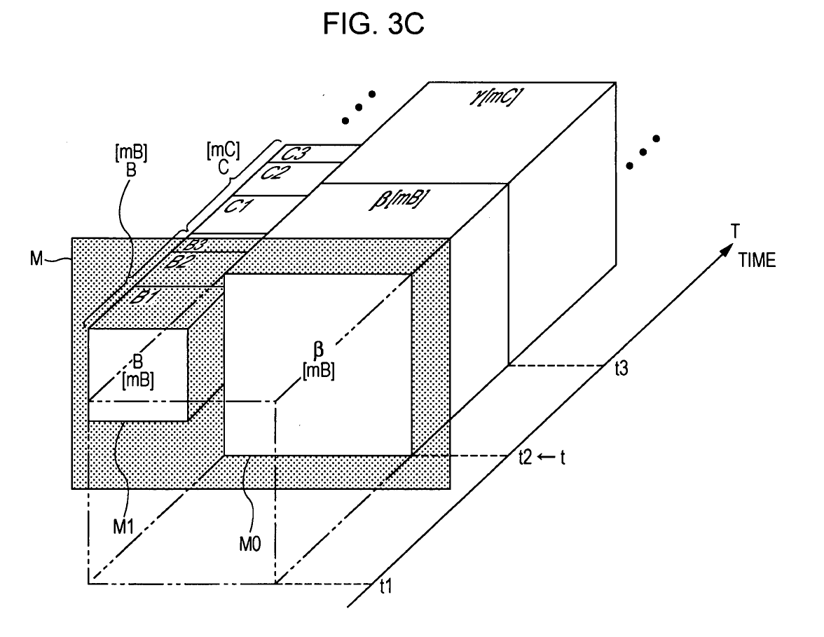

### 1-3. Configuration of Display Apparatus, FIG. 2, FIGS. 3A to 3C

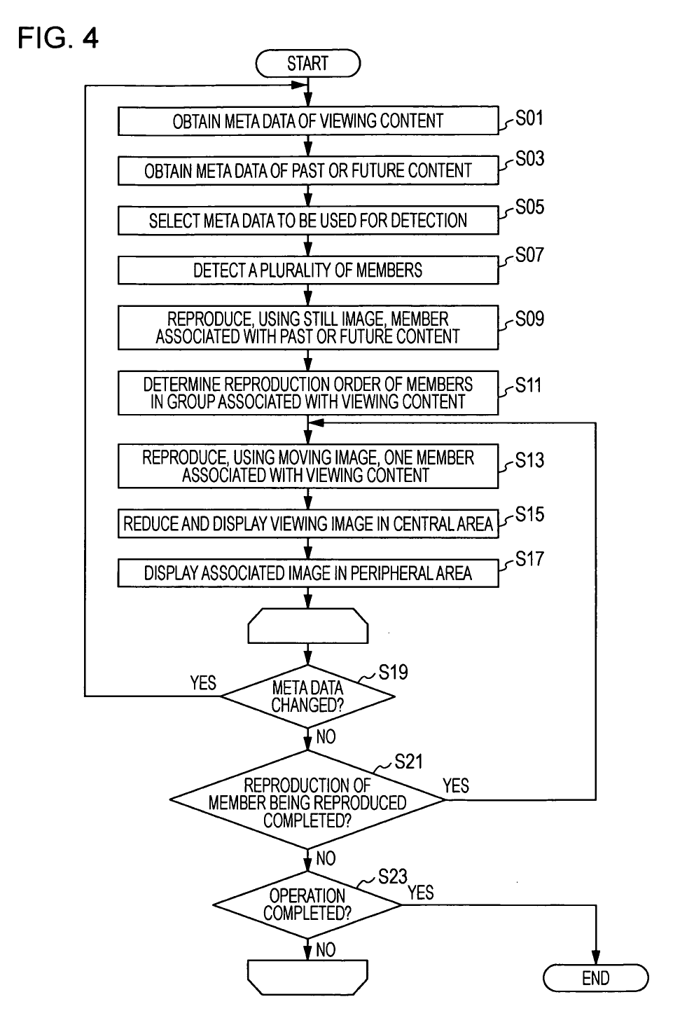

### 1-4. Operation of Display Apparatus, FIG. 4

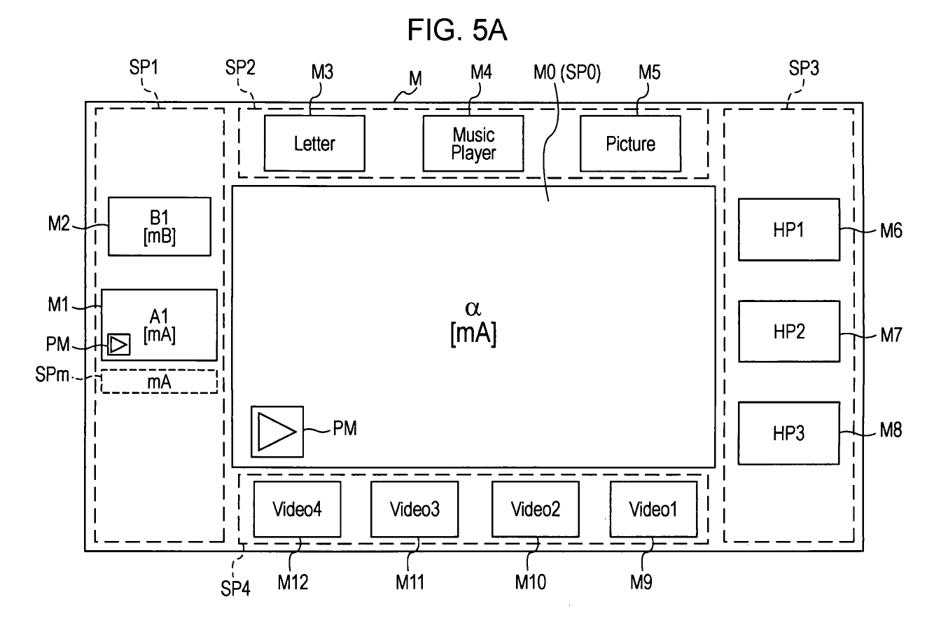

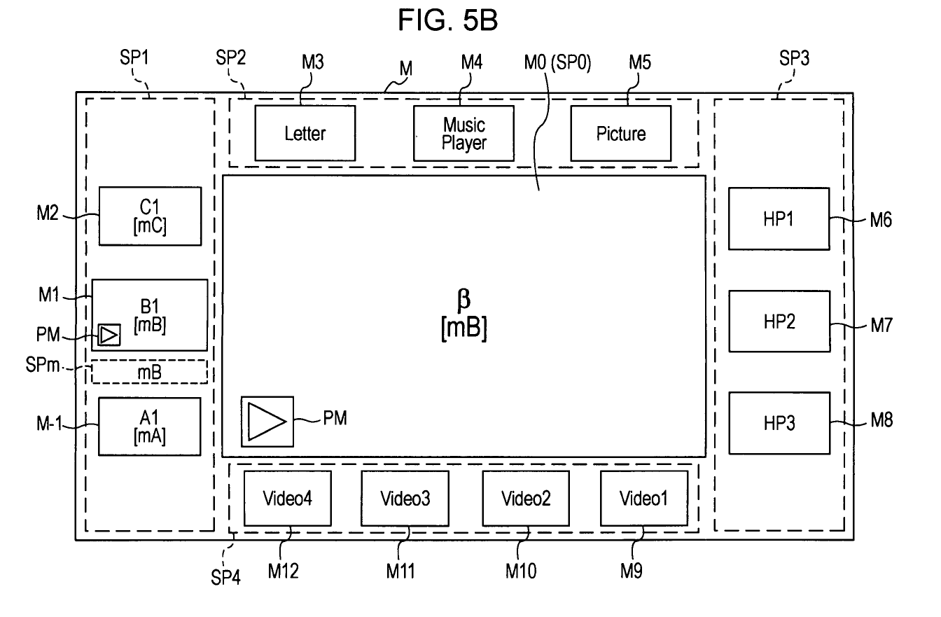

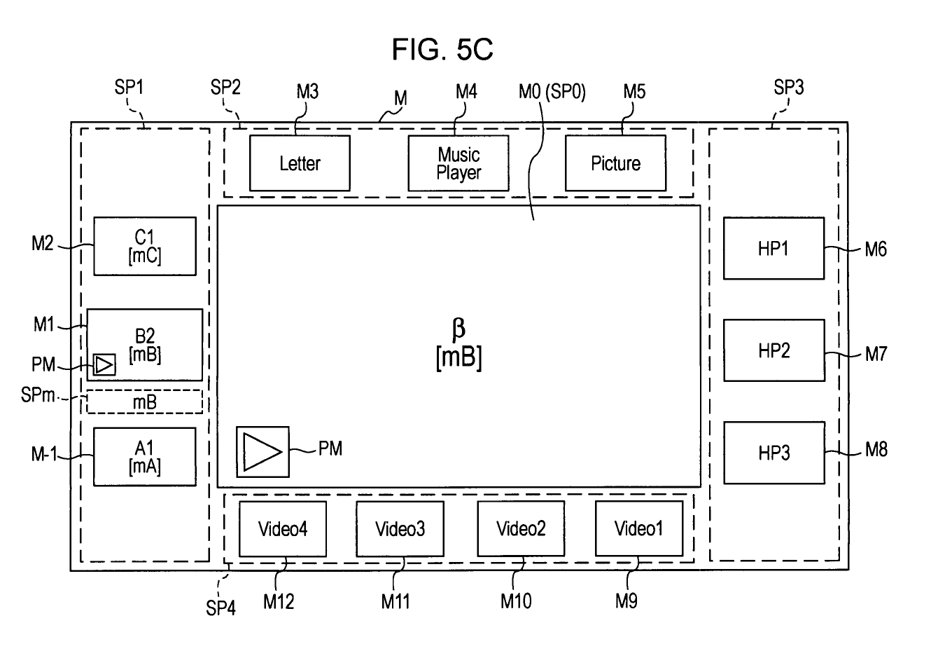

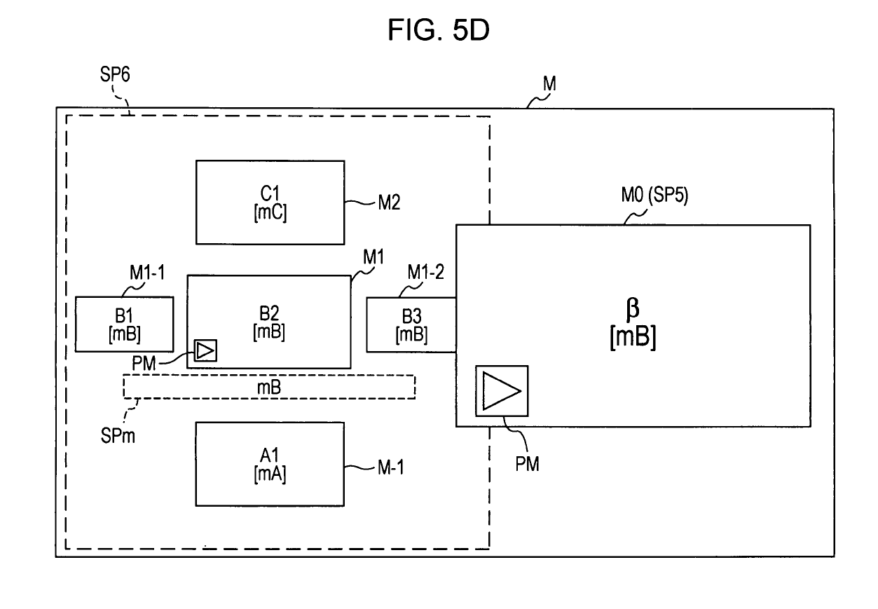

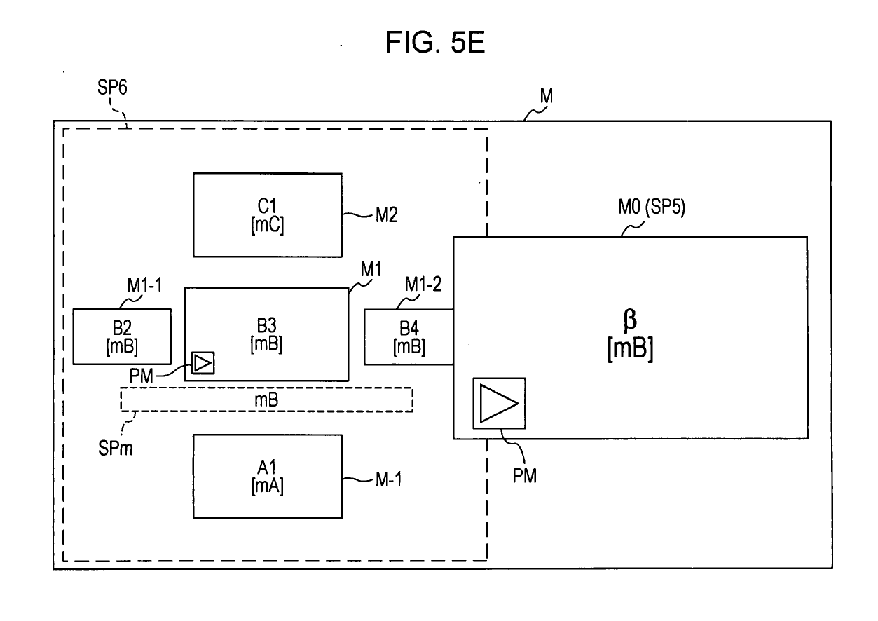

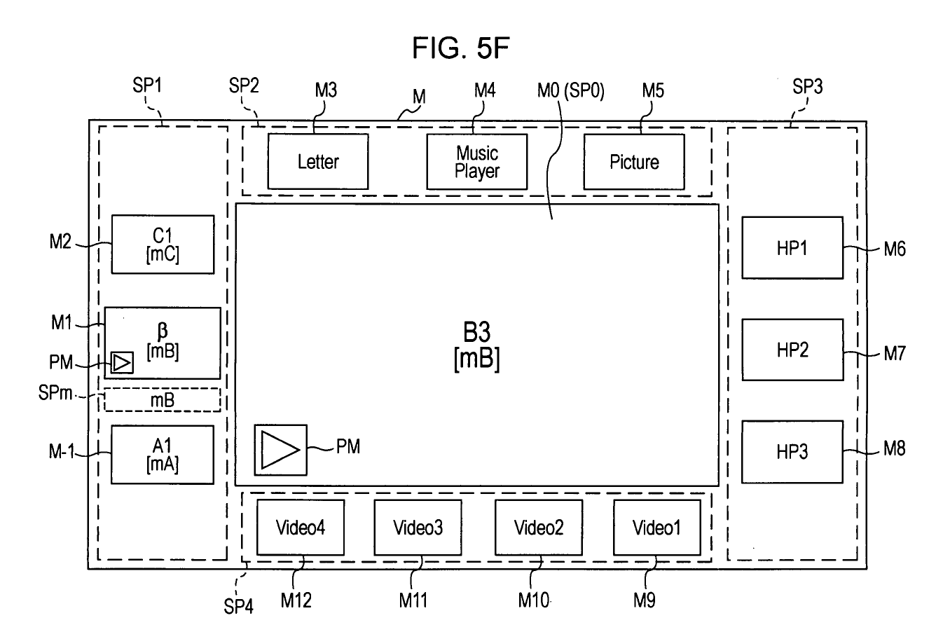

### 1-5. Example of Operation of Display Apparatus, FIGS. 5A to 5F

### 1-6. Example of Advantages

### 2. Modifications of First Embodiment, etc.

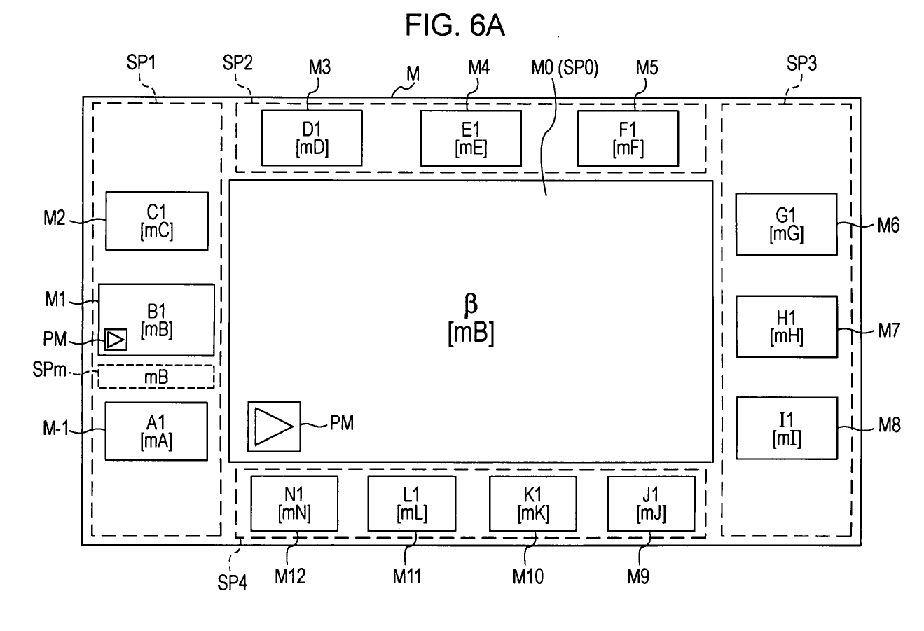

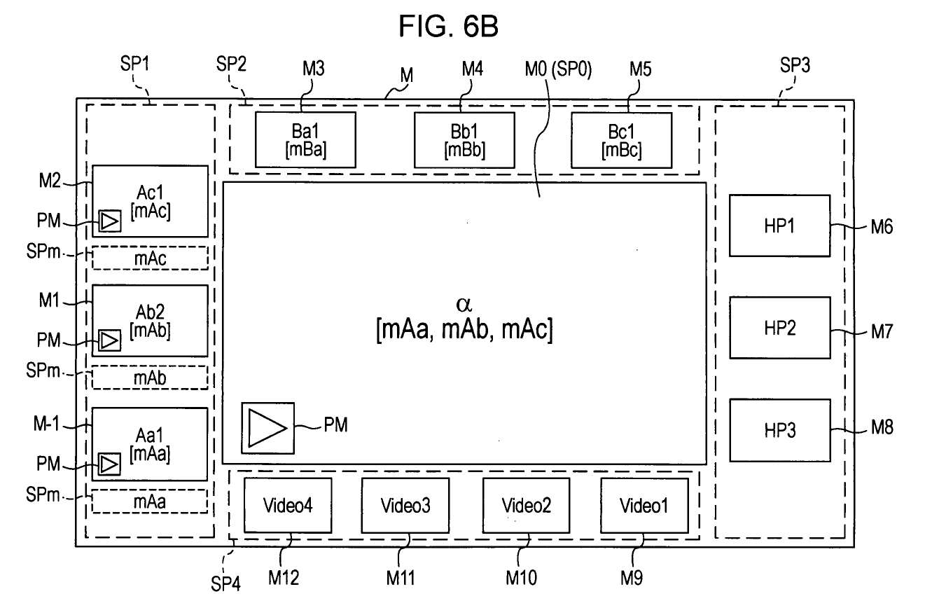

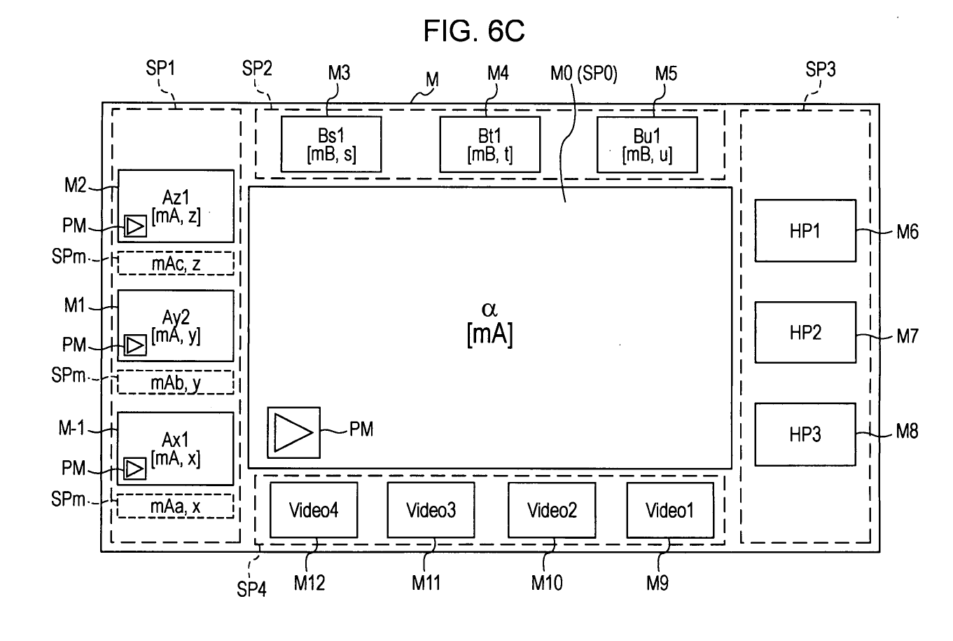

### 2-1. First Modification, FIG. 6A

### 2-2. Second Modification, FIG. 6B

### 2-3. Third Modification, FIG. 6C

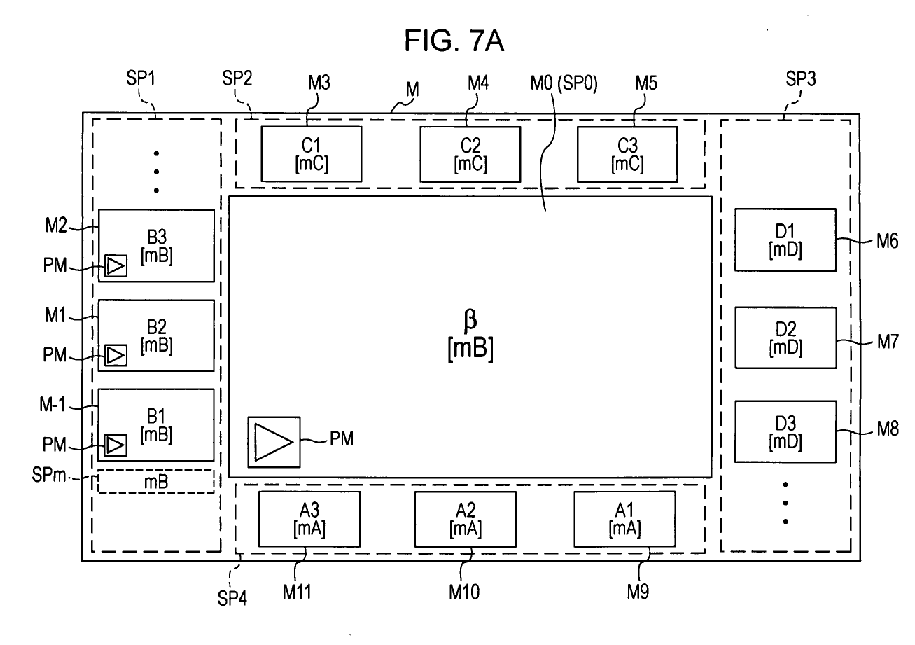

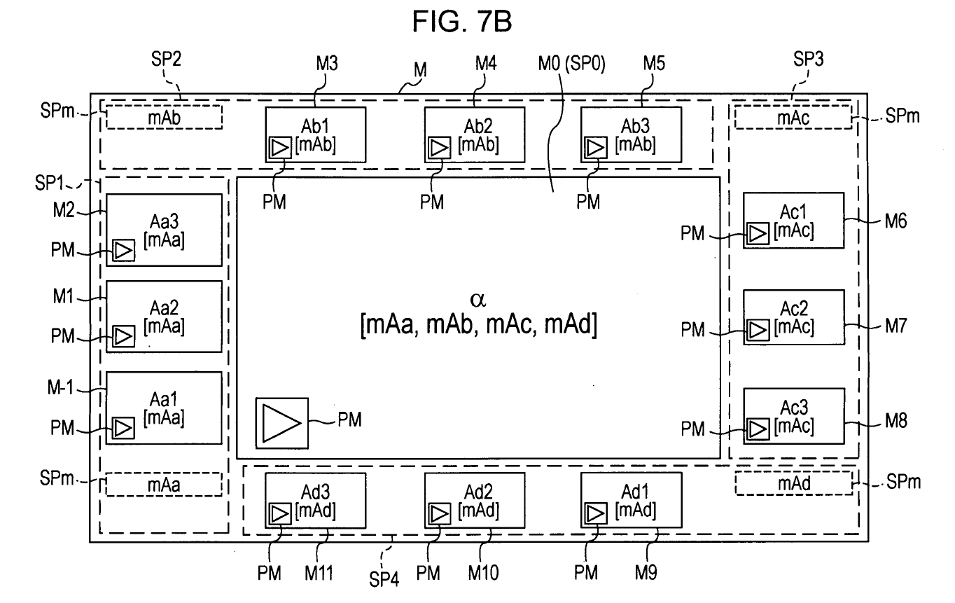

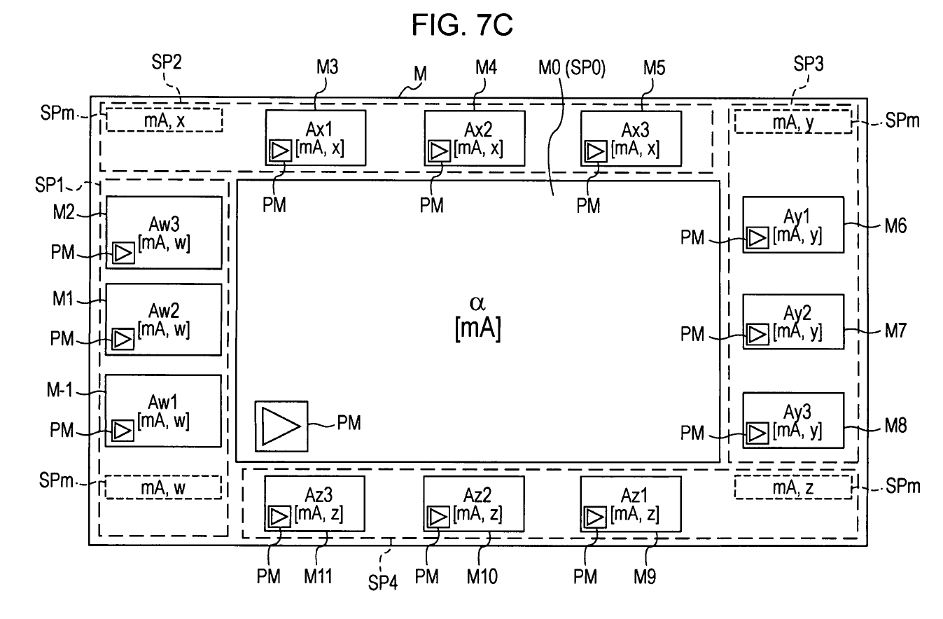

### 2-4. Fourth Modification, FIG. 7A

### 2-5. Fifth Modification, FIG. 7B

### 2-6. Sixth Modification, FIG. 7C

### 1. First Embodiment

### 1-1. Configuration of Display System

First, with reference to FIG. 1, in order to satisfactorily describe a display apparatus according to a first embodiment of the present invention, the outline configuration of a display system including the display apparatus according to an embodiment will be described. FIG. 1 is an illustration showing the outline configuration of the display system according to the first embodiment of the present invention. Although each component of a display system 1 shown in FIG. 1 does not necessarily constitute one system, for the convenience of description, each component will be described as constituting one system.

As shown in FIG. 1, the display system 1 according to the present embodiment includes a display apparatus 10, a controller 2, an antenna 3, a broadcast station 4, a connection line 5, a network 6, and an information distribution server 7.

The display apparatus 10 displays images contained in reproduction content data on the display screen. At this time, it is not necessary for the display apparatus 10 to reproduce the content data, and the display apparatus 10 can also obtain the reproduction content data. However, in the following, for the convenience of description, a description will be given of a case in which the display apparatus 10 reproduces content data.

The display apparatus 10 is able to perform operations in response to an “operation signal” that is input by the user by operating operation buttons of the controller 2 and the display apparatus 10, and the like. It is assumed that, in the present embodiment, the controller 2 is provided with, for example, at least up, down, right and left selection buttons, and a select button, and that when the user presses a button, an operation signal corresponding to the button is output from the controller 2. Upon receiving these operation signals, the display apparatus 1 performs various operations. Of course, the display apparatus 10 not only responds to the operation of the user, but also performs an automatic operation.

The display apparatus 10 is also able to display content data stored therein. In addition, it is possible to externally obtain content data to be displayed. Examples of this obtaining source include external devices (not shown), such as a reproduction device, a game machine, and a recording device, which can be connected to the broadcast station 4, the information distribution server 7, and the display apparatus 10. However, the obtaining source of the content data is not limited particularly, and various obtaining sources may be used as long as they are capable of obtaining content data. As shown in FIG. 1, the display apparatus 10 is able to receive a broadcast wave, such as a terrestrial broadcast wave or a satellite broadcast wave, which is broadcast in a wireless manner from the broadcast station 4 and on which content data is carried by using the antenna 3 so as to obtain the content data. Furthermore, the broadcast form of the content data from the broadcast station 4 is not limited to a wireless broadcast and, for example, a cable broadcast via the connection line 5, or an information distribution method via a network 6 such as the Internet, may be used. Thus, the display apparatus 10 is connected to the network 6. Furthermore, various information distribution servers 7 are connected to the network 6, and it is possible for the display apparatus 10 to obtain content data from these information distribution servers 7.

### 1-2. Examples of Content Data

Before a specific configuration of the display apparatus 10 according to the present embodiment is described, examples of content data displayed by the display apparatus 10 in the present embodiment will be described.

Each item of content data (hereinafter also referred to simply as “content”) includes an image in a wide sense or is attached with an image. The image may be a moving image or a still image.

In a case where a moving image is contained in content data, one item of content data may be, for example, one unit (for example, a scene, a chapter, a video recording unit, or the like) that is reproduced as one moving image. That is, for example, each of a plurality of scenes contained in one program/movie/video recording or the like corresponds to one item of content data. Examples of content data containing this moving image include each scene of a broadcast or a program that is cable broadcast, each chapter contained in a movie or the like, content data of a moving image created by the user, and content data of a moving image that can be obtained the user.

On the other hand, in a case where content data contains a still image, one item of content data may be one still image. However, here, for the convenience of description, a collection of a plurality of still images, which is usually handled often as one collection, in which specific meta data is common, will be described as one item of content data. Examples of such content data include a plurality of still images captured during the same event, a plurality of still images collected in one folder, a plurality of still images contained in one display list, and a plurality of still images forming an album. The one item of content data is displayed as a moving image as a result of a plurality of still images contained therein being sequentially displayed every predetermined time periods like a slideshow.

That is, in the present embodiment, the reproduction and display as a “moving image” is assumed to include both the reproduction and display of the content data of the moving image and sequential reproduction and display of each still image of content data of a plurality of still images. On the other hand, the reproduction and display as a “still image” is assumed to include reproduction and display of one cut (one still image) of content data of a moving image, or reproduction and display of one still image of content data of a plurality of still images.

It is not necessary for content data to be data that mainly includes images. For example, in a case where content data mainly contains music data, also, the display apparatus 10 according to the present embodiment is able to display this content data. In this case, one item of music data is attached with meta data, such as the name, the genre, the artist, and the album title, and with a still image, such as the jacket photograph and the logo of the music, an image photograph, and the photograph of the artist. Thus, the display apparatus 10 handles the meta data, the jacket photograph, the logo, the image photograph, the photograph of the artist, and the like as one still image of the music data. This applies the same for not only content containing music data, but also execution data (so-called software) executed by the display apparatus 10, or text data. Therefore, a description will be given below by assuming that these items of data will be handled similarly to the case of still images. However, a still image and a moving image may coexist in one item of content.

### Meta Data

Each item of content data is attached with or associated with meta data. The “meta data” refers to data representing attributes and features of content, and is attached with or associated with content data as text data. Examples of meta data include the name of the content, the type (genre) of the content, the outline of the content, the information on performers and producers, the viewership targeted by the content, the information provided to the viewer in association with the content, the broadcast form and the obtaining method, the time length necessary for the reproduction of the content data, the time at which the content was video recorded or sound recorded, the time at which the content was sold or made public, the time at which the content became popular, and the reproduction history of the content data. Such meta data may be, for example, an EPS (electronic program guide system).

### Association Characteristics, Etc.

On the other hand, for example, while one content data being reproduced is being displayed, the display apparatus 10 according to the present embodiment is able to display associated content data associated with the content data being reproduced as well on the basis of the meta data of the content data being reproduced. Thus, in order to distinguish between one item of content data being reproduced and associated content data, the former will also be referred to as “viewing content (example of content data being reproduced)”, and the latter will also be referred to as “associated content (example of associated content data)”. Then, an image contained in viewing content will also be referred to as a “viewing image (example of a reproduction image)”, and an image contained in associated content will also be referred to as an “associated image”. Furthermore, in a case of being simply referred to as “content”, it indicates content data in the manner described above and is assumed to include both viewing content and associated content. In a case of being simply referred to as an “image”, it is assumed to include both a viewing image and an associated image.

Furthermore, the display apparatus 10 according to the present embodiment makes a determination as to the presence or absence of the association characteristics with respect to viewing content on the basis of the meta data of associated content and the meta data of viewing content. That is, the display apparatus 10 makes a determination as to the presence or absence of the association characteristics with the associated content of the viewing content by checking the meta data of the viewing content against the meta data of the associated content and in accordance with whether or not the meta data is associated with each other. For example, in the case of the same meta data or conceptually close meta data, both the meta data are determined to be associated with each other. In the following, for the convenience of description, a description will be given of a case in which when meta data is the same, the viewing content and the associated content are determined to be associated with each other. However, for example, in a case where viewing content is attached with a plurality of items of meta data, all the meta data is not necessary to match each other. For example, in a case where only part of meta data is common, also, it is determined that the viewing content and the associated content are associated with each other. Furthermore, for example, the display apparatus 10 may refer to the degree of matching of both the meta data and determine those with a high degree of matching to have association characteristics. Meta data used for the determination of the association characteristics of both the content can be set as appropriate.

### Groups and Members

The display apparatus 10 according to the present embodiment is able to display a plurality of associated content, each having the same association characteristics, which can be associated with viewing content. A plurality of associated content having the same association characteristic in the manner described above will also be referred to as a “group” here (an example of a plurality of associated content data having an association characteristic). Furthermore, each item of the associated content contained in the group will also be referred to as a “member” here.

Examples of these groups and members are shown in Table 1. For example, each scene contained in one program and one movie (group) becomes a member. In this case, the scenes are associated with one another on the basis of a program or meta data with regard to the movie name, the creation date, the video recording date, and the like. Furthermore, for example, each video recording unit of a home movie recorded in one event (group) becomes a member. The video recording units are associated with one another using meta data, such as, for example, the creation date, the creator, the event name, and part of a file name. Furthermore, information will be made available regarding a still image. For example, each album or each slideshow captured in the same event (group) becomes a member. In this case, the albums or the slideshows are associated with one another on the basis of meta data, such as the image-capturing date, the image-capturing person, the event name, and part of a file name. Furthermore, for example, each folder in which a plurality of photographs are stored becomes a member. In this case, the folders are associated with one another on the basis of, such as, for example, a part of the name of the folder, the creation date, the creator name, and some of file names in the folder. Furthermore, information will be made available regarding a file or the like to be handled by regarding it as corresponding to a still image. For example, each playlist with which a plurality of music files are sequentially reproduced or are reproduced collectively becomes a member. The playlists are associated with one another on the basis of meta data, such as the name of the playlist, the genre of the playlist, the creation date of the playlist, the creator name, artists of music contained in the playlist, or the like. Furthermore, each album in which a plurality of items of music data are collected becomes a member. The albums are associated with one another on the basis of meta data, such as the artist name, the creator, the creation date, the purchase date, the genre, the title of the album, or the like. Furthermore, for example, each package in which a plurality of software are collected becomes a member. The packages are associated with one another on the basis of meta data, such as the manufacturing source, functions and content of the software, the manufacturing date, the purchase date, the compliant OS, or the like. Furthermore, for example, each folder in which a plurality of text data are stored becomes a member. The folders are associated with one another on the basis of meta data, such as, for example, part of the name of the folder, the creation date, the creator name, and some of file names in the folder.

TABLE 1

| Type | Group | Member |
|---|---|---|
| Broadcast (Moving image) | Program | Each scene |
| | | (chapter) |
| Movie (moving image) | Movie | Each scene |
| | | (chapter) |
| Home movie (moving | Event | Each scene |
| image) | | (recording unit) |
| Photograph (still image) | Event | Each album |
| Photograph (still image) | Event | Each slideshow |
| Photograph (still image) | Creation date | Each folder |
| Music (corresponding to | Genre | Each playlist |
| still image) | | |
| Music (corresponding to | Artist | Each album |
| still image) | | |
| Software (corresponding | Manufacturing | Each package |
| to still image) | source | |
| Text data (still image) | Creation date | Each folder |

The example of groups and members shown as an example here is only an example, and various variations can be considered. For example, a plurality of different types of files may form a group. That is, for example, there may be a case in which one scene of a moving image is contained, as one of albums of still images, in that album (member). Furthermore, of course, there can be a case in which one scene of a moving image is contained, together with a plurality of albums, in one event (group). That is, members contained in a group may be different types of files in the case of a plurality of associated content having the same association characteristic, which can be associated with viewing content correspondingly. In the present embodiment, in the manner described above, a plurality of still images or equivalents of still images are collected into one associated content. In this case, a plurality of files forming one associated content may be different types of files as long as they are a plurality of files, in which specific meta data is common, which are often handled collectively.

### 1-3. Configuration of Display Apparatus

Next, a description will be given, with reference to FIG. 2 and FIGS. 3A to 3C, of a specific configuration of the display apparatus 10 according to the present embodiment. FIG. 2 is an illustration showing the configuration of the display apparatus according to the present embodiment. FIGS. 3A to 3C are diagrams conceptually illustrating the operation of the display apparatus according to the present embodiment.

As shown in FIG. 2, the display apparatus 10 includes a content storage unit 11, a content obtaining unit 12, a reproduction unit 13, a display controller 14, an audio output unit 15, a meta data obtaining unit 16, a content detector 17, and a display screen M.

The content obtaining unit 12 obtains content to be displayed by the display apparatus 10. The content obtaining unit 12 is able to switch content to be obtained in response to, for example, an operation signal input through an operation by a user. That is, the content to be obtained by the content obtaining unit 12 is content (i.e., viewing content) that is selected and desired to be viewed by the user. At this time, a plurality of items of contents are recorded in the content storage unit 11, and the content obtaining unit 12 is able to obtain, for example, viewing content from this content storage unit 11. Furthermore, the content obtaining unit 12 is able to obtain viewing content from, for example, an external device (not shown), such as a reproduction device, a game machine, a recording device, or the like, which can be connected to the broadcast station 4, the information distribution server 7, and the display apparatus 10 other than the content storage unit 11. That is, the viewing content obtaining source of the content obtaining unit 12 is not limited particularly.

There is a possibility that content is in a form in which it is normally difficult to read information contained in the content, such as in which, for example, a plurality of information, such as a video signal, an audio signal, meta data, and the like are collected, compressed, or encrypted. In that case, the content obtaining unit 12 may convert the obtained content into a readable form, such as, for example, dividing the content into a plurality of items of information, decompressing it, or combining it. Furthermore, in a case where the broadcast content is to be obtained, the content obtaining unit 12 may function as a tuner or the like. However, regarding such conversion and tuning functions, the content obtaining unit 12 may of course have an obtaining source that obtains content.

The reproduction unit 13 reproduces the viewing content obtained by the content obtaining unit 12. At this time, it is also possible for the reproduction unit 13 to simultaneously reproduce one or more members (associated content) detected by the content detector 17 (to be described later) in addition to the viewing content obtained by the content obtaining unit 12. Furthermore, it is possible for the reproduction unit 13 to reproduce one or more of a plurality of content as a moving image and reproduce the other content as still images. The determination as to reproduction as a moving image or reproduction as still images may be performed by the reproduction unit 13, but in the present embodiment, it is assumed that a display controller 14 (to be described later) performs the determination.

The meta data obtaining unit 16 obtains the meta data of the viewing content, that is, the content data being reproduced. At this time, the meta data obtaining unit 16 obtains, for example, the meta data attached to the viewing content from the content obtaining unit 12, the reproduction unit 13 or the like. However, the obtaining source of the meta data is not limited to these examples. For example, in a case where meta data associated with viewing content has been recorded in the content storage unit 11, the external information distribution server 7, the broadcast station 4, or the like, and can be obtained, it is possible for the meta data obtaining unit 16 to obtain the meta data associated with these viewing content.

The content detector 17 detects the associated content (that is, associated with the viewing content on the basis of the meta data of the viewing content obtained by the meta data obtaining unit 16. At this time, the content detector 17 detects a plurality of members (that is, a group) having the same association characteristic with respect to the viewing content. At this time, similarly to the content obtaining unit 12, the content detector 17 detects a member from an external device (not shown), such as a reproduction device, a game machine, or a recording device, which can be connected to, for example, the content storage unit 11, the broadcast station 4, the information distribution server 7, and the display apparatus 10. That is, the member obtaining source of the content detector 17 is not limited particularly.

Furthermore, similarly to the content detector 17, the content obtaining unit 12 may convert the detected content into a readable form, such as, for example, dividing the content to a plurality of information, decompressing it, or combining it. Furthermore, in a case where the content detector 17 is to obtain broadcast content, the content detector 17 may function as a tuner or the like. However, regarding such conversion and tuning functions, the content detector 17 may of course have an obtaining source that obtains content.

A description will be given more specifically of an example of a member detection method employed by the content detector 17. The content detector 17 searches the obtaining source of the member on the basis of the meta data of the viewing content. At this time, in a case where a plurality of items of meta data of the viewing content exist, it is preferable that the content detector 17 selects one meta data and uses it for a search. The meta data used for a search may be, for example, the day of the viewing content, the creator, the obtaining source, the performer, and part of the title, but is not particularly limited. Furthermore, the meta data used for a search may be preset. The meta data may also be changed as appropriate by the content detector 17 in accordance with, for example, the content of specific meta data, such as the genre of the viewing content. Then, the content search unit 17 detects a member to which meta data related to the meta data used for a search is attached or associated. At this time, the content search unit 17 detects, as a member associated with viewing content, not only a member for which there is a match of meta data, but also, for example, a member having a high degree of matching or a member to which the meta data is conceptually close.

Therefore, for example, in a case where the viewing content is changed from one content to another content, the content detector 17 sequentially detects different members (members whose group differs) in accordance with the change of the meta data as a result of the viewing content being changed. In a case where the meta data is changed even though the viewing content is not changed, similarly, the content detector 17 sequentially detects different members in accordance with the change of the meta data.

Furthermore, in a case where there are a plurality of members that are associated with the viewing content, the content detector 17 obtains the plurality of members, that is, the group.

In addition, preferably, the content detector 17 also detects a member associated with past or future content on the basis of the meta data of the viewing content (will also be referred to as “past content” and “future content”) that is continuously reproduced before or after the current viewing content. For example, in a case where a member associated with past content is to be detected, when the past content has been reproduced, the content detector 17 has detected a member corresponding to the past content. Therefore, in this case, it is possible for the content detector 17 to obtain the member detected in the past without performing a search. Furthermore, in a case where a member associated with future content is to be detected, preferably, the meta data obtaining unit 16 obtains in advance the meta data of future content from, for example, the broadcast station 4, the information distribution server 7, or the content storage unit 11.

At least one or more members contained in one or more groups (groups associated with the viewing content, the future content, and the past content) detected by the content detector 17 are output to the reproduction unit 13, whereby they are reproduced.

The display controller 14 causes the viewing image of the viewing content reproduced by the reproduction unit 13 and associated images of one or more members to be displayed on a display screen M. In a case where the content detector 17 detects a plurality of members, the display controller 14 makes a determination as to which members should be reproduced as a moving image, which members should be reproduced as still images, and which member should not be reproduced. At this time, the display controller 14 is able to simultaneously display a plurality of members having the same association characteristic on the display screen M by causing the reproduction unit 13 to simultaneously reproduce a plurality of members as a moving image or still images. On the other hand, the display controller 14 is able to sequentially display a plurality of members having the same association characteristic on the display screen M by causing the reproduction unit 13 to sequentially reproduce a plurality of members as a moving image or still images. At this time, it is also possible for the display controller 14 to determine the order in which the members are reproduced. Examples of the determination of the reproduction order include the order of the member names, the order in which the members are arranged, the order in which the members are obtained, the order of the data sizes of the members, and an ordinary reproduction order.

The display controller 14 according to the present embodiment causes, for example, each member to be reproduced and displayed in the manner described below. That is, first, the display controller 14 causes the reproduction unit 13 to reproduce the members of a group associated with the viewing content as a moving image and causes the associated images to be displayed on the display screen M. On the other hand, the display controller 14 causes the members of the group associated with future or past content to be reproduced as still images and causes the associated images to be displayed on the display screen M. As a consequence, the display controller 14 according to the present embodiment causes one associated image of a member of the group associated with the future or past content to be displayed as a still image on the display apparatus. On the other hand, the display controller 14 according to the present embodiment determines the order in which the members within the group associated with the viewing content are reproduced, sequentially reproduces the members in accordance with the reproduction order one by one, and causes the moving image to be displayed on the display screen M. As a result, the display controller 14 causes the associated images of a plurality of members having the same association characteristic to be displayed on the display screen M. As a result, while the viewing image of the viewing content is being displayed on the display screen M, the members within the group associated with the viewing content are sequentially displayed as a moving image in a seamless manner. Then, one of the members associated with the future or past content is arranged and displayed as a still image.

Furthermore, as described above, if the meta data of the viewing content is changed, the content detector 17 sequentially detects different groups in accordance with the change of the meta data. Therefore, in a case where the meta data of the viewing content is changed, the display controller 14 causes, in accordance with the change, the associated images of the members of the different group to be sequentially displayed as a moving image in a seamless manner on the display screen M.

A description will be given below, with reference to FIGS. 3A to 3C, of the flow of content to be displayed on the display screen M by the display apparatus 10 including the display controller 14 according to the present embodiment. In particular, here, a description will be given of a case in which the meta data of the viewing content is changed and a case in which although the meta data is the same, a member within a group associated with the viewing content is changed.

FIGS. 3A to 3B conceptually show changes of a viewing image M0 of viewing content displayed on the display screen M and an associated image M1 of a member of a group associated with viewing content with respect to the time axis T. That is, as shown in FIG. 3A, three content α, β, and γ are arranged as viewing content along the time axis T, and these content are continuously reproduced and displayed. Furthermore, the content α, β, and γ are attached with meta data mA, mB . . . mC, respectively. At the point in time shown in FIG. 3A, the content α is viewing content, and the content β and γ are future content. With respect to this, the meta data obtaining unit 16 obtains the meta data mA of the viewing content α, and on the basis of the meta data mA, the content search unit 17 searches for members A1 to A4 of the group associated with the viewing content α and obtains them. Here, for the convenience of description, the case in which the meta data match (for example, meta data mA) shows a case of having an association characteristic with respect to the viewing content α. Furthermore, the display controller 14 determines the reproduction order of the members A1 to A4 and arranges them along the time axis T.

Then, at the point in time shown in FIG. 3A, the display controller 14 causes the reproduction unit 13 to reproduce the member A1 as a moving image, and causes the associated image M1 the member A1 to be displayed on the display screen M in such a manner as to be arranged with the viewing image M0 of the viewing content α.

After that, since the point in time shown in FIG. 3B is a point in time between the reproduction start time t1 of the viewing content α and the reproduction end point in time t2, the meta data mA of the viewing content α is the same as that of FIG. 3A. Therefore, the display controller 14 causes a member within the group A of the viewing content α to be displayed. In FIG. 3B, since the reproduction of the moving image of the member A1 has been completed, the reproduction unit 13 is made to reproduce the next member B2 as a moving image, and the associated image M1 is displayed on the display screen M.

On the other hand, at the point in time shown in FIG. 3C, since the reproduction of the content α is completed and the reproduction of the content β is started, the meta data of the viewing content has been changed to mB. As a result, the meta data obtaining unit 16 obtains the meta data mB of the viewing content β, and on the basis of the meta data mB, the content search unit 17 searches for members B1 to B3 of the group B associated with viewing content β and obtains them. Then, the display controller 14 determines the reproduction order of the members B1 to B3 and arranges them along the time axis T. At the point in time shown in FIG. 3C, the display controller 14 causes the reproduction unit 13 to reproduce the member B1 as a moving image and causes the associated image M1 of the member B1 to be displayed on the display screen M in such a manner as to be arranged with the viewing image M0 of the viewing content β.

Furthermore, the display controller 14 determines the display positions of the viewing image of the viewing content, the associated image of the member to be reproduced, and the like on the display screen M as described below. That is, the display controller 14 causes the reproduction image to be displayed in the central area of the display screen M and causes the associated images to be displayed in the peripheral area of the central area on the display screen M in such a manner that the viewing image (an example of the reproduction image) and the associated images do not superpose each other. At this time, the display controller 14 adjusts the display magnification ratio of the viewing image and the associated images, so that the images of a magnitude that falls within each area are displayed. This display screen M will be described more specifically in the example of the operation of the display apparatus 10 (to be described later).

Referring again to FIG. 2, the remaining configuration of the display apparatus 10, that is, the audio output unit 15, will be described.

In a case where an audio signal is contained in the viewing content that is being reproduced by the reproduction unit 13, the audio output unit 15 obtains the audio signal and outputs the sound. The audio of the member, which is reproduced by the reproduction unit 13, can be output. However, it is preferable that the audio output unit 15 according to the present embodiment does not output the audio of the member.

### 1-4. Operation of Display Apparatus

Next, a description will be given, with reference to FIG. 4, the operation of the display apparatus 10 according to the present embodiment. FIG. 4 is an illustration showing the operation of the display apparatus according to the present embodiment.

While the viewing content is being reproduced, when an operation signal requesting that associated content be obtained, first, the display apparatus 10 performs step S01.

In step S01, the meta data obtaining unit 16 obtains the meta data of the viewing content. Then, the process proceeds to step S03.

In step S03, the meta data obtaining unit 16 obtains the meta data of past or future content. Then, the process proceeds to step S05.

In step S05, the content search unit 17 selects meta data used for a search of a member within the meta data of the viewing content. Furthermore, similarly, the content search unit 17 selects meta data to be used for a search with respect to past content and future content. Then, the process proceeds to step S07.

In step S07 (example of content detection step), on the basis of the meta data determined in step S05, the content search unit 17 detects a group (a plurality of members) associated with each of viewing, past, and future content. Then, the process proceeds to step S09.

In step S09, the display controller 14 causes the reproduction unit 13 to reproduce members associated with past and future content as still images. Then, the process proceeds to step S11.

In step S11, the display controller 14 determines the reproduction order of a plurality of members contained in the group associated with the viewing content. Then, the process proceeds to step S13. However, in a case where only one member is contained in the group, step S11 can be omitted.

In step S13, in accordance with the order determined in step S11, the display controller 14 causes the reproduction unit 13 to reproduce one member of a group associated with the viewing content as a moving image. Then, the process proceeds to subsequent steps S15 to S23 (examples of display step).

In steps S15 to S23, first, step S15 is processed. In step S15, the display controller 14 reduces the viewing image and displays it in the central area of the display screen M. Then, the process proceeds to step S17.

In step S17, the display controller 14 reduces the associated image and displays them in the peripheral area of the central area on the display screen M. That is, the display controller 14 causes the associated images of the member associated with the viewing content to be displayed as a moving image on the display screen M, and causes another associated image to be reproduced as a still image on the display screen M. At this time, for example, the display controller 14 is able to cause the associated images of the member associated with the viewing content to be displayed as a moving image in color and cause another associated image to be reproduced in a sepia color or in coloring with a small number of colors, and is able to further reduce and display the associated images. In this case, it is possible for the display controller 14 to further accentuate the associated images associated with the viewing content. Then, the process proceeds to step S19.

In step S19, the meta data obtaining unit 16 confirms whether or not the meta data of the viewing content has changed. In the case that the meta data has changed, processing of step S01 and subsequent steps is repeated. On the other hand, in the case that the meta data has not changed, the process proceeds to step S21.

In step S21, the reproduction unit 13 confirms whether or not the member is contained in the group associated with the viewing content and the reproduction of the member being reproduced as a moving image has been completed. In the case that the reproduction of the member has been completed, processing of step S13 and subsequent steps is repeated. On the other hand, in the case that the reproduction of the member has not been completed, the process proceeds to step S23.

In step S23, the display apparatus 10 confirms whether or not an operation signal instructing the completion of the presentation operation of the associated content is input. Then, in the case that such an operation signal is input, the operation is completed, and when the operation signal is not input, processing of step S19 and subsequent steps is repeated.

### 1-5. Example of Operations of Display Apparatus

Examples of changes of an image to be displayed by the display apparatus 10 with respect to time through the operation, and changes as a result of operation will be described with reference to FIGS. 5A to 5F. FIGS. 5A to 5F are illustrations illustrating examples of operations of the display apparatus according to the present embodiment.

FIG. 5A shows images displayed on the display screen M in a case where the operation starts and, for example, steps S01 to S17 are performed.

As shown in FIG. 5A, in the central area SP0 of the display screen M, the viewing image M0 of the viewing content α is displayed. On the other hand, in the peripheral area SP1, one member A1 of the group associated with the viewing content α is displayed as a moving image (associated image M1). A mark PM schematically shows that the content is displayed as a moving image. At this time, it is preferable that, in the vicinity (a meta data display area SPm) of the associated image M1 reproduced as a moving image and in the associated image M1, the meta data mA used for detecting association characteristics is displayed so as to allow the user to recognize the association characteristics. On the side of the member A1 associated with the viewing content α, a member B1 associated with the future content β is displayed as a still image (associated image M2) in such a manner as to be arranged therewith. Preferably, the associated image M2 is displayed smaller than the associated image M1.

On the other hand, in the other peripheral areas SP2 to SP4, various other images can be displayed. For example, in an upper peripheral area SP2, icons or the like indicating other content and other functions that can be provided by the display apparatus 10 are displayed. Furthermore, in a right-side peripheral area SP3, an HP (home page) or the like that can be obtained by the display apparatus 10 is displayed. In addition, in a peripheral area SP4, another moving image or the like that can be provided by the display apparatus 10 is displayed. However, the images shown in the peripheral areas SP2 to SP4 shown in FIG. 5A are only examples, and the present embodiment is not limited to these examples.

Here, a description will be given by assuming that the viewing content α is a program (may be one scene) that has been recorded in advance in the content storage unit 11 by the user.

A case in which a predetermined time period has then passed, the viewing content α (one scene) is completed, and the next viewing content β is reproduced is shown in FIG. 5B. As shown in FIG. 5B, when the viewing content is changed from the content α to the content β, the meta data is changed. Therefore, from step S19, processing of step S01 and subsequent steps is performed once more, and an image shown in FIG. 5B is displayed on the display screen M. That is, the member displayed as a moving image is changed from the member A1 of the group A to the member B1 of the group B associated with the viewing content β. At this time, preferably, the display position of the associated image of the moving image is not changed, and only the member displayed as a moving image is moved. That is, when the state shifts from FIG. 5A to FIG. 5B, preferably, the position of the associated image M1 of the member A1 of the group A is moved downward and is displayed as a new associated image M-1 (still image). As a consequence, preferably, the position of the associated image M2 (FIG. 5A) of the member B1 of the group B is moved downward and is displayed as a new associated image M1 (moving image). On the other hand, at the position at which the member B1 has been displayed in FIG. 5A, preferably, a member C1 of a group C associated with new future content is displayed as a still image (associated image M2).

Then, in a case where time has passed further and the reproduction of the member B1 that has been reproduced and displayed as a moving image is completed, processing of step S13 and subsequent steps is performed from step S21. As a result, as shown in FIG. 5C, as the associated image M1 of the moving image, a member B2 reproduced next to the member B1 is displayed as a moving image.

Here, it is assumed that, for example, the meta data mB is the creation date (recording date) and is content obtained at a travel destination where the member B2 was present at around the time the viewing content β was recorded, and the user shows interest in the content. Then, it is assumed that the user selects, for example, an operation button in the direction in which the member B2 is displayed with respect to the viewing content, and the operation signal is obtained by the display apparatus 10. Then, the display controller 15 causes a video shown in FIG. 5D to be displayed on the display screen M.

That is, the viewing image M0 is reduced and moved to the right-side area SP5 of the display screen M, and associated images M-1, M1, and M2 are expanded and moved to the left-side area SP6 of the display screen M. Then, the other members B1 and B3 of the group B are displayed to the left and right of the associated image M1 of the member B2 reproduced as a moving image. Here, by selecting up, down, right, and left operation buttons, it is possible for the user to move the member to be reproduced as a moving image from the member B1 to other members B1, B3, A1 . . . C1. FIG. 5E shows a case in which the user has selected an operation button representing the right direction and the member B3 of the same group B is reproduced as a moving image. As described above, the display controller 14 performs display in such a manner that members having different association characteristics are arranged in the up-and-down direction and members having the same association characteristics are arranged in the right-and-left direction, thereby making it possible to provide a user interface, like a cross media bar (XMB)®.

In the state shown in FIG. 5E, in a case where the user presses, for example, the operation button indicating selection, in response to the operation signal, the display controller 14 causes the member B3 reproduced as a moving image to be displayed in a central area SP0 as shown in FIG. 5F. As a result, the member B3 becomes new viewing content, and the content β becomes a new member. As a result, it is possible for the user to enjoy the content presented by the display apparatus 10.

### 1-6. Example of Advantages

In the foregoing, the display apparatus 10 according to the first embodiment of the present invention has been described. According to the display apparatus 10, it is possible to provide associated content (member) associated with viewing content in response to the change in the meta data of the viewing content. Usually, the user's interest is directed to something associated with that being viewed. Therefore, if the viewing content changes from time to time, the user's interest also changes from time to time. According to the display apparatus 10, it becomes possible to present appropriate associated content suited to the interests of the user, which change from time to time in the manner described above, making it possible to increase the chances of presenting content matching the preference of the user. Furthermore, usually, the brain of the user thinks various thoughts. Therefore, such a content providing method makes it possible to provide content matching the interests of the user at the point in time, and also the content providing method matches the way the brain of the user functions. Thus, it is expected that the content providing method is also useful for preventing the brain from deteriorating.

Furthermore, the display apparatus 10 displays the viewing image of the viewing content and the associated images of the associated content in such a manner as not to superpose each other. The user views the viewing image, and if, for example, the associated images are superposed on the viewing image, there is a risk that the user may receive a lot of stress. On the other hand, the display apparatus 10 displays the viewing image and the associated images so as not to superpose each other, making it possible to provide the associated images to the user without obstructing the viewing activity of the user.

Furthermore, the display apparatus 10 is able to display associated content associated with the viewing content as a moving image in the peripheral area of the viewing content. Human static vision is high in the central portion (central visual field) of the field of vision, but is decreased in the peripheral portion of the field of vision (peripheral field of view, eccentric field of view). On the other hand, dynamic vision in the peripheral field of view is very high when compared to static vision. Therefore, the display apparatus 10 according to the present embodiment is able to increase the recognition power of the user with respect to the associated content by using the characteristics of such human vision.

In addition, the display apparatus 10 changes the associated content to be displayed as a moving image in accordance with the change of the viewing content. Therefore, it is possible to enable the user to recognize the association characteristics between the associated content and the viewing content.

Furthermore, in a case where the associated content associated with future content is displayed in such a manner as to be arranged and the viewing content is future content, the display apparatus 10 displays the associated content as a moving image. Therefore, it is possible to make the user to expect next viewing content and expect associated content to be displayed next as a moving image, making it possible to present new content.

In addition, since the display apparatus 10 is able to display a plurality of associated content associated with the viewing content as a moving image, it is possible to provide various associated content to the user.

### 2. Modification of First Embodiment, Etc.

In the foregoing, the display apparatus 10 according to the first embodiment of the present invention has been described. For such a display apparatus 10, various variations are considered on the basis of an associated content display method. Accordingly, in the following, some of such variations will be described. However, it is added that variations described herein are only examples. Even when the associated content display method is changed, the display apparatus 10 can be configured in the same manner as in the foregoing. Accordingly, a description will be given with emphasis on points differing from the first embodiment.

### 2-1. First Modification

First, a description will be given below, with reference to FIG. 6A, of a modification of a peripheral area in which a member is displayed by the display apparatus 10. FIG. 6A is an illustration showing a first modification of the display apparatus according to the present embodiment.

In the first embodiment, display positions of members associated with viewing, past, and future content, respectively, are in the peripheral area SP1 left to the center area SP0 on the display screen M. Then, a description has been given of a case in which members associated with one past or future content nearest to the viewing content are displayed in the peripheral area SP1. However, it is also possible for the display apparatus 10 to display members of a plurality of past content and members of a plurality of future content and also possible to display associated images of these members in various peripheral areas. An example thereof is shown in FIG. 6A.

As shown in FIG. 6A, it is also possible for the display apparatus 10 to display the associated images of the members A1 to N1 in all the peripheral areas SP1 to SP4. Of course, it is also possible to display the associated images of the members in some of the peripheral areas SP1 to SP4. Furthermore, as shown in FIG. 6A, it is also possible for the display apparatus 10 to display the members C1 to N1 of a plurality of future content. Of course, similarly, it is also possible to display a member A1 and the like of a plurality of past content.

### 2-2. Second Modification

Furthermore, in the first embodiment, a case has been described in which the content detector 17 selects one meta data among a plurality of meta data of the viewing content, and detects a member having an association characteristic on the basis of the meta data. However, meta data used for a search may be one or more. An example thereof is shown in FIG. 6B.

In the second modification shown in FIG. 6B, a case in which the content detector 17 has selected three meta data mAa, mAb, and mAc is shown. In this case, for each of the meta data mAa, mAb, and mAc, each of the members Aa1, Ab2, and Ac1 of the groups Aa, Ab, and Ac associated with the viewing content α is detected. Therefore, the content detector 17 detects a plurality of members having plural association characteristics for each of the associations with respect to the viewing content. Furthermore, in this case, preferably, the display controller 14 causes the members Aa1, Ab2, and Ac1 corresponding to the meta data mAa, mAb, and mAc, respectively, to be arranged simultaneously as shown in FIG. 6B so as to be reproduced as a moving image and displayed.

By displaying the associated content (members) for each of the plurality of meta data as described above, the display apparatus 10 according to the second modification is able to increase the probability at which the displayed associated content matches the interest of the user.

### 2-3. Third Modification

In a case where the content search unit 17 searches for a member by using one meta data, a modification shown in FIG. 6C is considered. FIG. 6C is an illustration showing a third modification of the display apparatus according to the present embodiment.

That is, a case in which the members Ax1, Ay2, Az1, and the like contained in the detected group A, which differ from the viewing content, can be classified into a plurality of subgroups Ax, Ay, and Az in the group A is expected. The classification into the subgroups Ax, Ay, and Az can also be performed on the basis of the association characteristics of the other meta data x, y, and z attached to the members Ax1, Ay2, and Az1, respectively.

More specifically, on the basis of the respective meta data x, y, and z of a plurality of members Ax1, Ay2, Az1, and the like having the same association characteristic (meta data mA), the display controller 14 classifies a plurality of members Ax1, Ay2, Az1 and the like into a plurality of subgroups Ax, Ay, and Az for each association characteristic (meta data x, y, and z) differing from the association characteristic (meta data mA). Then, the display controller 14 sequentially causes, for each of the subgroups Ax, Ay, and Az, the members classified into the subgroups Ax, Ay, and Az to be reproduced as a moving image and displayed.

In this case, the display apparatus 10 is able to make the user conscious not only the association characteristic with respect to the viewing content, but also the association characteristic for each member. Such a content presentation method makes it possible to provide the user with various ways of enjoying the display apparatus 10. For example, as meta data for forming a subgroup, the reproduction history of each content (already reproduced (x), not yet reproduced (y, z), the degree of popularity (not yet reproduced (y) with high popularity, not yet reproduced (z) with low popularity)) of each content is used. Then, the display apparatus 10 becomes possible to make the user recognize such degree of popularity and history as well. Usually, the user tends to want to view content that is not yet reproduced rather than content that has already been reproduced, and tends to want content with a high popularity rather than content with a low popularity. Thus, associated content in which such a tendency is reflected can be provided.

### 2-4. Fourth Modification

In the first embodiment, a case in which members in one group are sequentially reproduced has been described. However, it is also possible for the display apparatus 10 to simultaneously provide members in one group. Examples thereof will be described in the following fourth to sixth modifications.

FIG. 7A is an illustration showing a fourth modification of the display apparatus according to the present embodiment. FIG. 7A shows a case in which the display controller 14 displays associated images of a plurality of members having the same association characteristic in such a manner as to be arranged. That is, the display controller 14 causes the reproduction unit 13 to reproduce, as a moving image, a plurality of members B1 to B3 associated with the viewing content β so as to be displayed in the peripheral area SP1. At this time, the display controller 14 is also able to cause, for example, a plurality of members C1 to C3 and D1 to D3 associated with future content to be displayed as still images in peripheral areas SP2 and SP3, respectively. In addition, the display controller 14 is also able to cause, for example, a plurality of members A1 to A3 associated with, for example, past content to be displayed as still images in the peripheral area SP4.

### 2-5. Fifth Modification

Furthermore, in a case where a plurality of members in the same group are to be displayed in such a manner as to be arranged, similarly to the second modification, it is possible to use a plurality of meta data for a search for a member. An example in this case is shown in FIG. 7B. FIG. 7B is an illustration showing a fifth modification of the display apparatus according to the present invention.

In the fifth modification shown in FIG. 7B, a case in which the content detector 17 has selected four meta data mAa, mAb, mAc, and mAd is shown. In this case, with regard to meta data mAa, mAb, mAc, and mAd, members Aa1 to Aa3, Ab1 to Ab3, Ac1 to Ac3, and Ad1 to Ad3 of the respective groups Aa, Ab, Ac, and Ad having an association with the viewing content α are detected. Therefore, with respect to the viewing content, the content detector 17 detects a plurality of members having a plurality of association characteristics for each association. Furthermore, in this case, the display controller 14 is able to display the members Aa1 to Aa3 of the group Aa as a moving image in such a manner as to be arranged in the peripheral area SP1, and is able to display the members Ab1 to Ab3 of the group Ab as a moving image in such a manner as to be arranged in the peripheral area SP2. Furthermore, the display controller 14 is able to display the members Ac1 to Ac3 of the group Ac as a moving image in such a manner as to be arranged in the peripheral area SP3, and is able to display the members Ad1 to Ad3 of the group Ad as a moving image in such a manner as to be arranged in the peripheral area SP4.

Similarly to the second modification, also, the display apparatus 10 according to the fifth modification is able to display associated content (members) for each of the plurality of meta data, thereby making it possible to increase the probability at which the displayed associated content matches the interest of the user.

### 2-6. Sixth Modification

In addition, in a case where a plurality of members in the same group are to be displayed in such a manner as to be arranged, similarly to the third modification, it is possible to classify the plurality of members into subgroups and possible to change the display position for each of the subgroups. An example in this case is shown in FIG. 7C. FIG. 7C is an illustration showing a sixth modification of the display apparatus according to the present embodiment.

That is, on the basis of the meta data w, x, y, and z of each of the plurality of members Aw1 to Az3 or the like having the same association characteristic (meta data mA), the display controller 14 classifies, for each association characteristic (meta data w, x, y, and z) differing from the same association characteristic (meta data mA), the plurality of members Aw1 to Az1 or the like into a plurality of subgroups Aw, Ax, Ay, and Az. Then, the display controller 14 is able to display the members Aw1 to Aw3 of the subgroup Aw as a moving image in such a manner as to be arranged in the peripheral area SP1, and is able to display the members Ax1 to Ax3 of the subgroup Ax as a moving image in such a manner as to be arranged in the peripheral area SP2. In addition, the display controller 14 is able to display the members Ay1 to Ay3 of the subgroup Ay as a moving image in such a manner as to be arranged in the peripheral area SP3, and is able to display the members Az1 to Az3 of the subgroup Az as a moving image in such a manner as to be arranged in the peripheral area SP4.

Also, in this case, similarly to the third modification, it is possible for the display apparatus 10 to make the user be conscious about not only an association characteristic with respect to the viewing content, but also an association characteristic for each member.

As has been described above, although the preferred embodiments of the present invention have been described in detail with reference to the attached drawings, the present invention is not limited to such examples. It is obvious for a person having ordinary knowledge in the art to which the present invention belongs to conceive various changes or modifications in the scope of the technical concept disclosed in the claims. It should be understood that, of course, the changes or modifications fall under the technical concept of the present invention.

For example, in the embodiments, a case in which the display apparatus 10 reproduces content data has been described. It is also possible for the display apparatus 10 to obtain content data reproduced by an external device. In this case, the reproduction of a member may be performed by the reproduction unit 13 of the display apparatus 10 and also, the display apparatus 10 may cause an external reproduction device to perform the reproduction of a member. In a case where the reproduction of a member is to be performed by an external reproduction device, it is not necessary for the display apparatus 10 to have the reproduction unit 13.

Furthermore, in the above-described embodiments, a case has been described in which, in a case where content data contains still images, one content data (members) is a collection (for example, an album) of a plurality of files in which specific meta data is common and which are often handled in a collective manner. However, the present invention is not limited to this example. For example, it is also possible to handle one content data (member) as one still image or the like. In this case, the reproduction of one member corresponds to that the member is displayed for a predetermined time period. Then, a group can be made to be, for example, a collection of a plurality of files that are handled as one content in the above-described embodiments. In this case, it is also possible for the display apparatus 10 to display members contained in the group associated with the viewing content simply as still images rather than being displayed as a moving image. However, for example, while the display apparatus 10 displays the member for a predetermined time period, preferably, the display apparatus 10 displays a still image as a moving image by making the still images of the member blink, by performing black and white reversal display thereof, by moving the display position, or by rotating the still image.

The series of processing operations in each of the above-described embodiments may be performed by dedicated hardware, but also these may be performed by software. In a case where the series of processing operations are to be performed by software, it is possible to realize the series of processing operations by causing a general-purpose or dedicated computer to execute a program. The computer may include a CPU (Central Processing Unit); a recording device such as an HDD (Hard Disk Drive), a ROM (Read Only Memory), or a RAM (Random Access Memory); a communication device connected to a network, such as a LAN (Local Area Network) or the Internet; an input device such as a mouse and a keyboard; a drive for reading and writing removable storage media, such as a magnetic disc such as a flexible disc, various optical discs such as a CD (Compact Disc), an MO (Magneto Optical) disc, or a DVD (Digital Versatile Disc), and a semiconductor memory; an output device, such as a display device such as a monitor device, and an audio output device such as a speaker and/or a headphone. Then, the computer may perform the series of the processing operations by executing a program recorded in the recording device or on removable storage medium, or a program obtained via the network.

In the present specification, steps written in the flowcharts may of course be performed in a time-series manner along the written order, and may also be performed concurrently or individually although they are not performed in a time-series manner. In some cases, even the order of steps performed in a time-series manner may of course be changed as appropriate.

It should be understood by those skilled in the art that various modifications, combinations, sub-combinations and alterations may occur depending on design requirements and other factors insofar as they are within the scope of the appended claims or the equivalents thereof.

What is claimed is:

1. A display apparatus comprising:
a content detector configured to, on the basis of meta data of content data being reproduced, detect associated content data associated with the content data being reproduced; and
a display controller configured to cause a reproduction image contained in the content data being reproduced to be displayed on a display screen and cause associated images contained in the associated content data detected by the content detector to be displayed as a moving image on the display screen,
wherein the display controller causes associated images of different associated content data that is sequentially detected by the content detector to be sequentially displayed on the display screen in accordance with the change of the meta data of the content data being reproduced.

2. The display apparatus according to claim 1, wherein the display controller causes the reproduction image to be displayed in the central area of the display screen and causes the associated images to be displayed in the peripheral area of the central area on the display screen in such a manner that the reproduction image and the associated images do not superpose one another.

3. The display apparatus according to claim 2, wherein the content detector detects a plurality of associated content data having the same association characteristic with respect to the content data being reproduced, and
wherein the display controller causes the associated images of the plurality of associated content data having the same association characteristic to be displayed in the peripheral area together with the reproduction image.

4. The display apparatus according to claim 3, wherein the display controller causes the associated images of the plurality of associated content data having the same association characteristic to be sequentially displayed in the peripheral area.

5. The display apparatus according to claim 4, wherein the content detector detects a plurality of associated content data having an association characteristic and a plurality of associated content data having another association characteristic with respect to the content data being reproduced, and
wherein the display controller causes the associated images of the plurality of associated content data having the association characteristic to be sequentially displayed in the peripheral area and causes the associated images of the plurality of associated content data having the other association characteristic to be sequentially displayed in the peripheral area.

6. The display apparatus according to claim 4, wherein, on the basis of meta data of each of the plurality of associated content data having the same association characteristic, the display controller causes associated images of a plurality of associated content data each having an association characteristic differing from the same association characteristic to be sequentially displayed in the peripheral area, and causes the associated images of a plurality of associated content data each having another association characteristic to be sequentially displayed in the peripheral area.

7. The display apparatus according to any one of claims 1 to 5, wherein, on the basis of meta data of content data that is continuously reproduced before or after the content data being reproduced, the content detector further detects associated content data associated with the content data that is continuously reproduced, and
wherein the display controller causes the associated images of the associated content data associated with the content data that is continuously reproduced to be displayed as still images on the display screen in such a manner as to be arranged with the associated images of the associated content data associated with the content data being reproduced.

8. The display apparatus according to claim 3, wherein the display controller causes the associated images of the plurality of associated content data having the same association characteristic to be displayed in such a manner as to be arranged in the peripheral area.

9. The display apparatus according to claim 8, wherein the content detector detects a plurality of associated content data having an association characteristic and a plurality of associated content data having another association characteristic with respect to the content data being reproduced, and
wherein the display controller causes the associated images of the plurality of associated content data having the association characteristic to be displayed in such a manner as to be arranged in one side of the central area in the peripheral area, and causes the associated images of the plurality of associated content data having the other association characteristic to be displayed in such a manner as to be arranged on the other side of the central area in the peripheral area.

10. The display apparatus according to claim 8, wherein, on the basis of meta data of each of the plurality of associated content data having the same association characteristic, the display controller causes the associated images of the plurality of associated content data each having an association characteristic differing from the same association characteristic to be displayed in such a manner as to be arranged in one side of the central area in the peripheral area, and causes the associated images of the plurality of associated content data each having another association characteristic to be displayed in such a manner as to be arranged in the other side of the central area in the peripheral area.

11. A display method comprising the steps of:
on the basis of meta data of content data being reproduced, detecting associated content data associated with the content data being reproduced; and
causing a reproduction image contained in the content data being reproduced to be displayed on a display screen and causing associated images contained in the associated content data detected in the content detection step to be displayed as a moving image on the display screen,
wherein, in the display step, the associated images of the different associated content data that is sequentially detected in the content detection step are to be sequentially displayed on the display screen in accordance with the change of the meta data of the content data being reproduced.
